(19) United States
(12) Patent Application Publication
(10) Pub. No.: US 2003/0035102 A1
(43) Pub. Date: Feb. 20, 2003

(54) Radiometer

(76) Inventors: Chris Dimas, North York (CA); John Kuta, Mississauga (CA)

Correspondence Address: Shawn D. Jacka, Bereskin & Parr, Box 401, 40 King Street West, Toronto, ON, M5H 3Y2, CA

(21) Appl. No.: 09/930,131

(22) Filed: Aug. 16, 2001

(51) Int. Cl. G01J 1/42

(52) U.S. Cl. 356/218

(57) ABSTRACT

A system and method for measuring radiation. In one embodiment, a radiometer includes an inlet port, a light sensor operatively coupled to the inlet port, and a direction sensor adapted to detect the orientation of the inlet port. In another aspect, a radiometer has a base, a housing pivotally mounted to the base, an aperture in the housing, a radiation sensor in communication with the aperture, and a direction sensor adapted to detect the orientation of the housing relative to the base. In yet another aspect, a radiometer has a housing including at least one aperture, and a radiation sensor adapted to detect the irradiance and direction of origin of radiation entering the aperture. A method is disclosed for detecting the irradiance of radiant energy from a source in at least two dimensions. The method involves the steps of providing a radiometer of the present invention and positioning the radiometer in the path of radiant energy emitted from the source.

### FIELD OF THE INVENTION

The present invention relates generally to the field of radiometry, with common but by no means exclusive application to radiometric measurement of manufacturing apparata for curing reactive materials. For greater clarity, when used herein, reference to “curable” and “reactive” materials and variations thereof is intended to mean polymeric materials which chemically transform with the application of sufficient energy, unless a contrary intention is apparent.

### BACKGROUND OF THE INVENTION

Manufacturing objects containing reactive materials commonly requires consistent power levels and distribution of curing radiation. This is particularly the case if the objects to be cured have narrow tolerance requirements for high quality control, often where reliability for safety or high performance is necessary.

Curing three dimensional objects raises additional difficulties in terms of measuring the power levels and distribution of the curing radiation in three dimensions.

Accordingly, the inventors have recognized a need for a system and method which are capable of measuring radiation distribution in at least two dimensions.

### SUMMARY OF THE INVENTION

This invention is directed towards a radiometer.

The radiometer includes an inlet port, a light sensor operatively coupled to the inlet port, and a direction sensor adapted to detect the orientation of the inlet port.

The invention is further directed towards a radiometer having a base, a housing pivotally mounted to the base, an aperture in the housing, a radiation sensor in communication with the aperture, and a direction sensor adapted to detect the orientation of the housing relative to the base.

In yet another aspect, the invention is also directed towards a radiometer having a housing comprising at least one aperture, and a radiation sensor adapted to detect the irradiance and direction of origin of radiation entering the aperture.

In a different aspect, the invention is also directed towards a method of detecting the irradiance of radiant energy from a source in at least two dimensions. The method involves the steps of providing a radiometer of the present invention and positioning the radiometer in the path of radiant energy emitted from the source.

### BRIEF DESCRIPTION OF THE DRAWINGS

The present invention will now be described, by way of example only, with reference to the following drawings, in which like reference numerals refer to like parts and in which:

FIG. 1 is a side schematic view of a first embodiment of the radiometry system made in accordance with the present invention.

FIG. 2 a top perspective view of a curing system configured to emit radiation in an arc of approximately 360°.

FIG. 3A is a logical flow diagram of a multi-step curing method employed in using the curing system made in accordance with the present invention.

FIG. 3B is a side schematic view of the radiometry system of FIG. 6, in use.

FIG. 4 is a graph of the measured irradiance of radiation correlated to angle of origin emitted by the curing system of FIG. 2 as detected by the radiometry system of FIG. 1.

FIG. 5A is a side schematic view of a second embodiment of the radiometry system made in accordance with the present invention.

FIG. 5B is a close-up schematic view of an alternate configuration of a reflector which may be used in the radiometry system of FIG. 5A.

FIG. 6 is a side schematic view of a third embodiment of the radiometry system made in accordance with the present invention.

### DESCRIPTION OF THE PREFERRED EMBODIMENTS

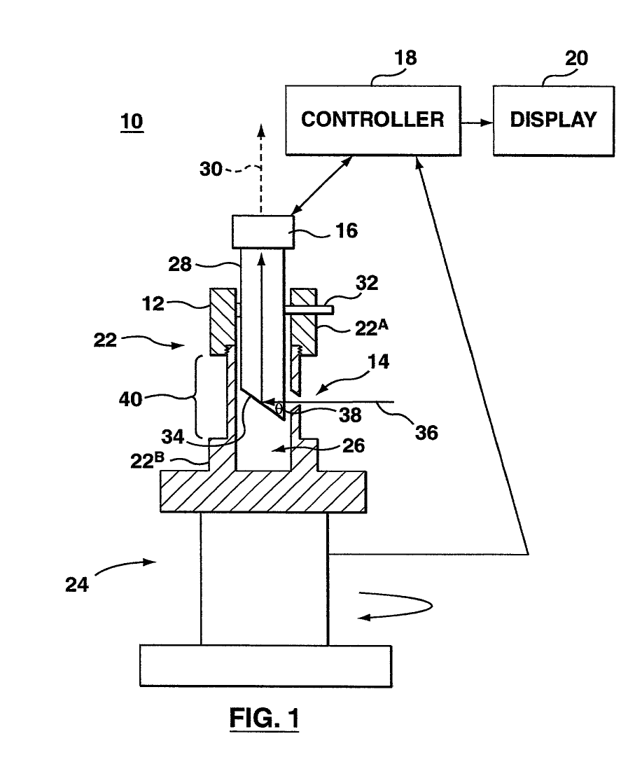

Illustrated in FIG. 1 is a first embodiment of the radiometry system of the subject invention. The radiometry system, shown generally as 10, includes a housing 12, an inlet port 14, a radiation sensor 16, a controller 18 and a display 20.

The housing 12 is generally cylindrical in shape and comprises an upper assembly 22 rotatably mounted to a rotation stage 24. Preferably the housing 12 is made of metal or other materials which are substantially unaffected by radiation of the type intended to be used in association with the radiometry system 10. As will be understood, the rotation stage 24 functions as a direction sensor and detects the orientation of the upper assembly 22 (preferably correlated specifically to the inlet port 14) relative to the rotation stage 24, and generates corresponding orientation data which is received by the controller 18. As well, the rotation stage 24 preferably also comprises orientation markings (not shown) to assist the user in correlating the orientation of the upper assembly 22 relative to the rotation stage 24. The inlet port 14 generally comprises a radiation passageway through the housing 12 in the upper assembly 22, typically in the form of an aperture.

The upper assembly 22 comprises a substantially tubular interior chamber 26 which contains a cladded glass rod waveguide 28 having a centred longitudinal axis 30 and fixed in position within the chamber 26, for example through the use of a set-screw 32 through the housing 12. The waveguide 28 is typically tubular, and more preferably substantially cylindrical. As will be understood, while the waveguide 28 has been described as being made of cladded glass, other materials suitable for acting as a waveguide may be used. Proximate the inlet port 14, the waveguide 28 comprises an angled face 34, facing away from the inlet port 14, as illustrated in FIG. 1.

As will be understood, the angle 38 of the face 34 (relative to the longitudinal axis 30) is selected based on the index of refraction of the material forming the waveguide 28 and the angle of the radiation entering the inlet port 14 (represented by vector 36). The angle 38 must be formed such that the angle that the incident radiation 36 makes with the normal of the face 34 is beyond the critical angle for the glass-air interface. In the instant example in which the waveguide 28 is of cladded glass and the incident radiation 36 is perpendicular to the longitudinal axis 30, the angle 38 of the face 34 is 45°, such that the incident radiation 36 is reflected 900 upwards towards the radiation sensor 16 by total internal reflection.

As well, the face 34 preferably comprises a diffusing surface, such as through the application of a diffusion coating, to obtain an isotropic irradiance measurement, as will be understood by one skilled in the art.

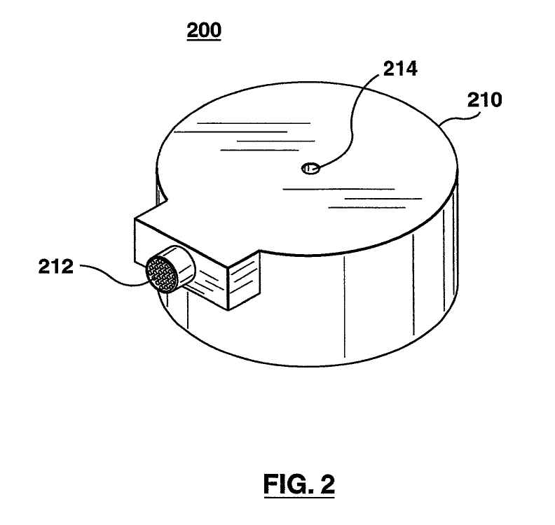

The upper assembly 22 may also comprise a recessed region 40 which is sized and shaped to receive a radiation emitting apparatus, such as the curing cylinder 200 illustrated in and discussed in relation to FIG. 2. At the indented portion, the housing 12 is generally narrow in diameter. Preferably the recessed region 40 is sized to enable the inlet port 14 to be positioned proximate the radiation emitter ports on the radiation emitting apparatus, while still allowing the upper assembly 22 to rotate with respect to the radiation emitting apparatus. As well, the recessed region 40 typically extends completely around the housing 12. As will be understood, the curing cylinder 200 or other radiation emitting apparatus to be tested by the radiometry system 10 is fixed in position relative to the rotation stage 24.

The upper assembly 22 may further comprise two upper assembly segments 22^{A} and 22^{B}. The upper segment 22^{A} is detachably mountable to the lower segment 22^{B}, such as by threaded mounting or friction fitting the two segments 22^{A} and 22^{B} together at the top of the recessed region 40. Such a configuration facilitates the positioning of the radiometry system 10 within a small location such as the radiation chamber 214 of the curing cylinder 200, discussed below in relation to FIG. 2.

The radiation sensor 16 may typically comprise a photodiode or an array of photodiodes or other devices capable of detecting irradiance and generating corresponding irradiance data. As will be understood, the controller 18 comprises memory storage and a suitably programmed CPU configured to receive and correlate orientation data and irradiance data from the rotation stage 24 and radiation sensor 16, respectively. The display 20 is operationally coupled to the controller 18 and may comprise a display screen, printer or other suitable device for presenting the correlated orientation and irradiance data to the user.

As will be understood, the angular resolution of the radiometry system 10 may be varied by altering the cross-sectional size of the inlet port 14. As will also be understood, the housing 12 and other components of the system 10 may be very compact in size, enabling the system 10 to take radiometry measurements within narrow spaces.

It should also be noted that when the upper assembly 22 is rotated by the rotation stage 24, the inlet port 14 transcribes a circular arc. Accordingly, as will be understood the radiometry system 10 may be used to detect the irradiance of curing radiation impinging on the surface of an object to be cured (such as a syringe or fibre optic cabling), having a circumference substantially equivalent to the circular arc transcribed by the inlet port 14. Correspondingly, the diameter of the housing 12 proximate the inlet port 14 may be sized to closely match the diameter of specific objects being cured.

Referring now to FIG. 2, illustrated therein is a cylindrical curing apparatus illustrated generally as 200, and which may be similar to the curing apparatus illustrated and described in co-pending U.S. patent application Ser. No. 98/873,199. The curing cylinder 200 has a housing 210 and an inlet port 212 for receiving radiation from a radiation emitting device (such as a light guide). The curing cylinder 200 also typically has several emitter ports positioned on the interior wall of the irradiation chamber 214. The irradiation chamber 214 is generally a tubular passageway into which objects to be cured may be inserted. As will be understood, the emitter ports are operatively coupled to the inlet port 212 and are configured to emit the received radiation radially inwardly and substantially about an arc of 360°. As noted above, the irradiation chamber 214 may closely match the dimensions of the recessed region 40 of the radiometry system 10.

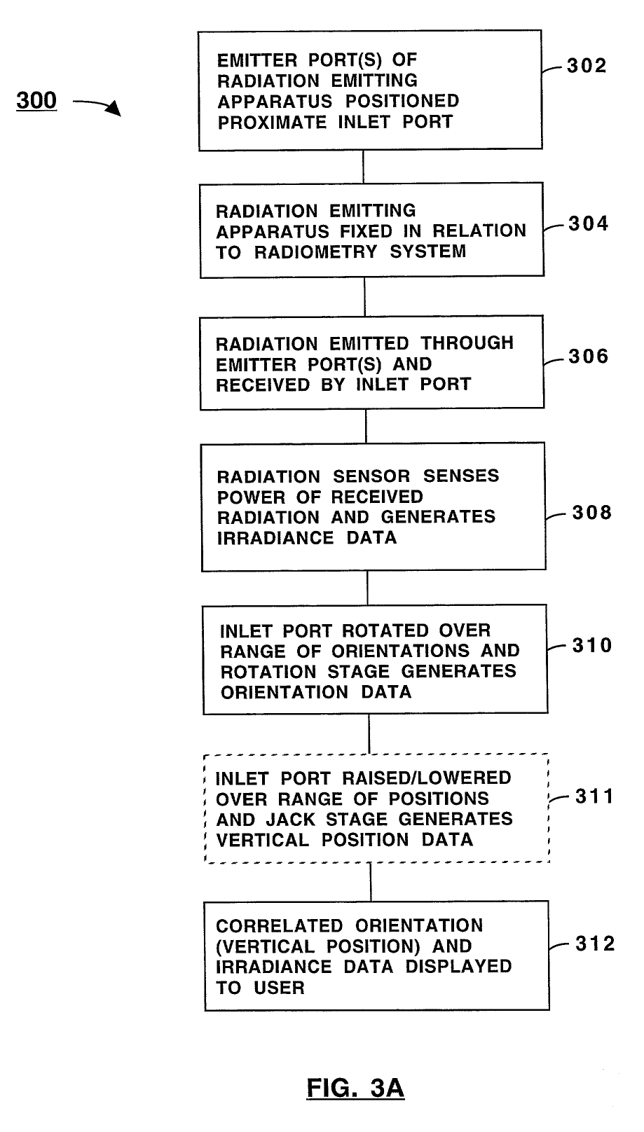

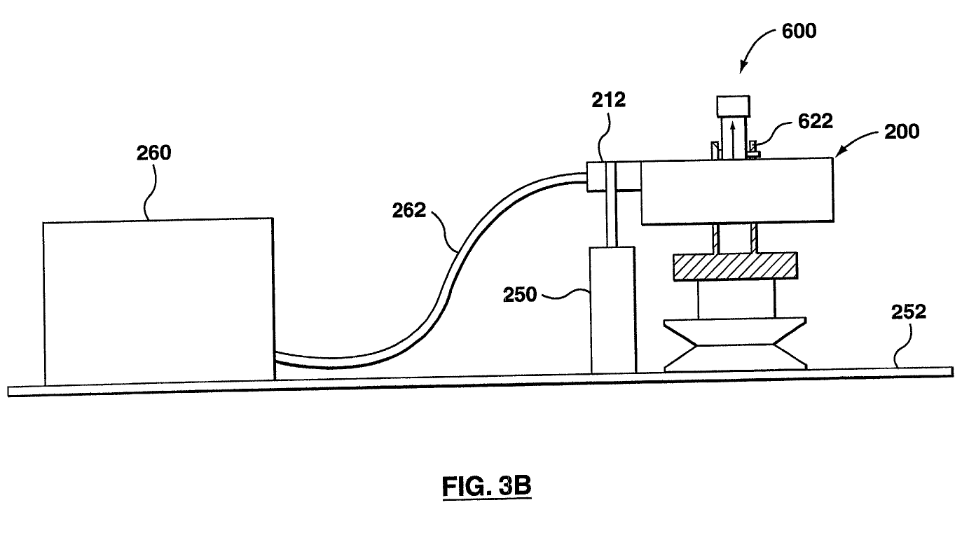

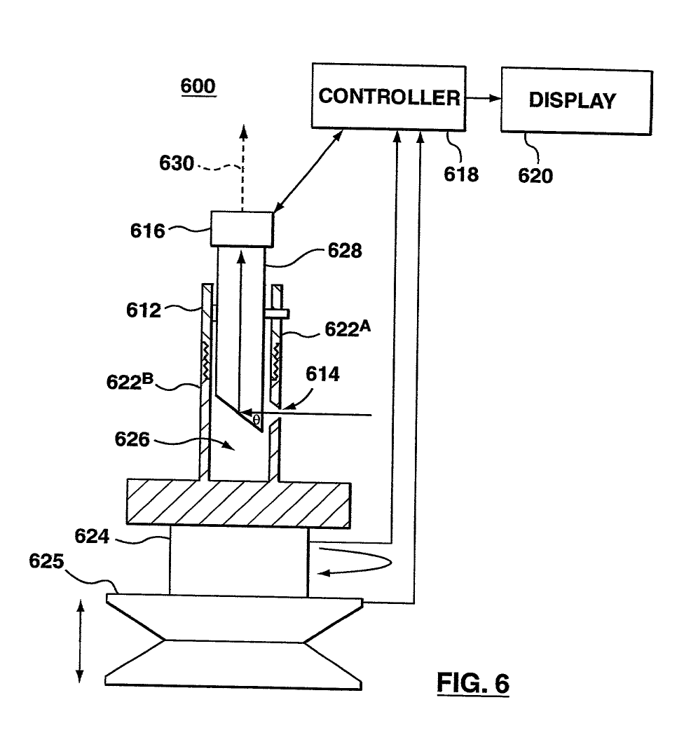

FIG. 3A depicts the method, shown generally as 300, employed in using the radiometry device 10, 600 (discussed below in relation to FIG. 6) of the present invention to test the uniformity of radiation emitted by a radiation source. In use, the radiation emitting apparatus (such as the curing cylinder 200) is positioned with its emitter port(s) proximate the inlet port 14, 614 typically by detaching the upper segment 22^{A}, 622^{A} from the lower segment 22^{B}, 622^{B} and inserting the lower segment 22^{B}, 622^{B} within the irradiation chamber 214, and rejoining the upper and lower segments 22^{A}, 622^{A}, 22^{B}, 622^{B}. Preferably, the upper assembly 22, 622 is concentrically positioned within the irradiation chamber. (Block 302) The radiation emitting apparatus is then fixed in relation to the rotation stage 24, 624 while allowing the upper assembly 22 to freely rotate. (Block 304)

The radiation emitting apparatus is then caused to emit radiation through its emitter port(s). (Block 306) While the apparatus continues to emit radiation, radiation is received by the inlet port and directed to the radiation sensor 16, which senses the power of the received radiation, and generates corresponding irradiance data (based on the cross-sectional area of the inlet port 14, 614) which is received by the controller 18. (Block 308) The upper assembly 22, 622 is then rotated to enable the inlet port 14, 614 to receive radiation from different orientations (and preferably over a range of orientations) relative to the emitting apparatus, and the rotation stage 24, 624 generates orientation data which is received by the controller 18, 618. In the case of the curing cylinder 200 which is configured to emit radiation substantially about an arc of 360°, the upper assembly 22, 622 is preferably rotated through 3600°. (Block 310) In the case of the radiometry system 600, the jack stage 625 may then be raised (or lowered as appropriate) to different vertical positions. At each vertical position, the rotation stage 624 may be rotated as discussed in relation to Block 310. (Block 311) The controller 18, 618 then correlates the orientation and irradiance data (and the vertical position data, in the case of controller 618), which are displayed to the user by the display 20, 620. (Block 312)

Illustrated in FIG. 3B is a side schematic view of a radiometry system 600 (described in greater detail in relation to FIG. 6, below) in use. The upper assembly 22 of the radiometry system 600 is positioned within the irradiation chamber 214 of a curing cylinder 200. The curing cylinder 200 is held in fixed position relative to the radiometry system 600 through the use of a clamp 250. The clamp 250 and radiometry system 600 are both preferably mounted to a workbench 252 or other suitable working surface. A radiation generating apparatus 260 is also provided, having a waveguide 262, such as a liquid light guide, coupled to the inlet port 212 of the curing cylinder 200.

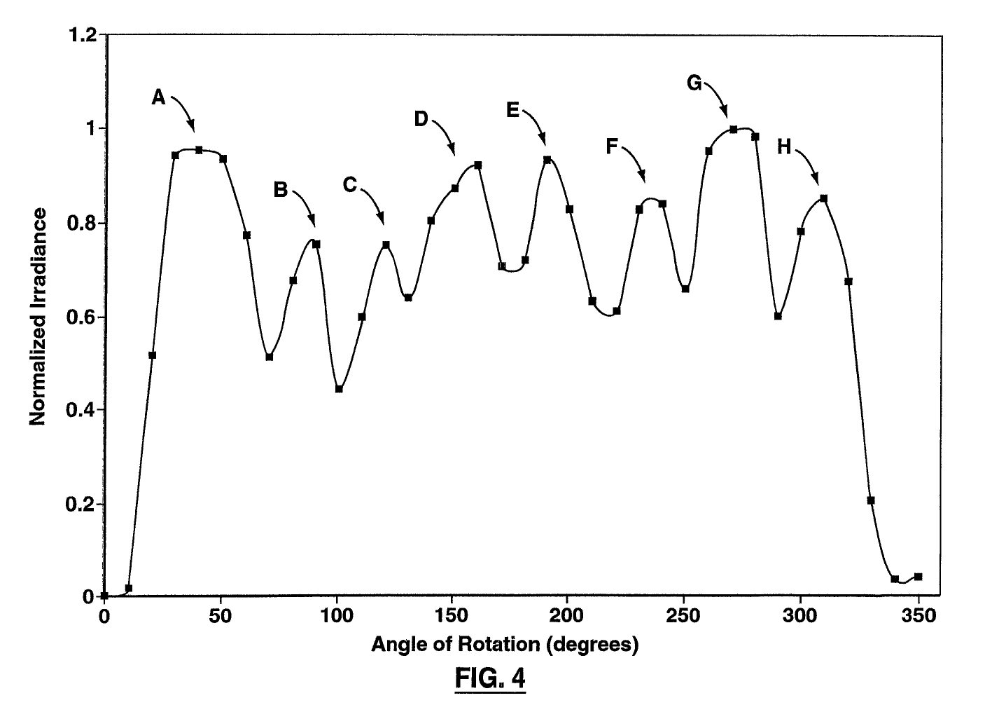

Referring now to FIG. 4, illustrated therein is a graph illustrating irradiance correlated to orientation, detected by a radiometry device 10 from a curing cylinder 200. On the graph, the irradiance data has been normalized in a range from 0 to 1, and has been captured in 100 increments (as indicated by the square data points). As indicated on the graph, the curing cylinder 200 tested by the radiometry device 10 has eight emitter ports (represented by peaks A-H), approximately evenly distributed around the irradiation chamber 214. However, the irradiance data also indicates a lack of uniformity in the levels of irradiance emitted by the various emitter ports A-H. As can be seen, the irradiance levels indicated for emitter ports B, C are approximately only 75% of the irradiance at emitter port G. This lack of uniformity may be sufficient to indicate that the curing cylinder 200 is defective.

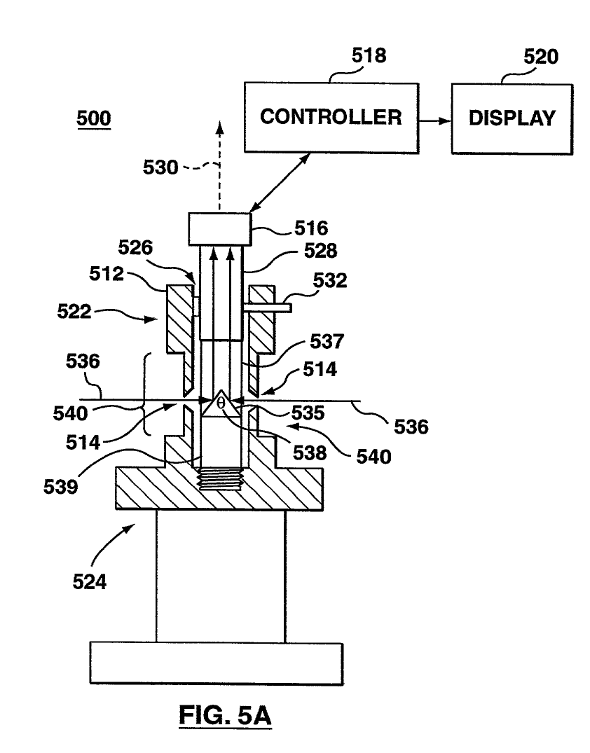

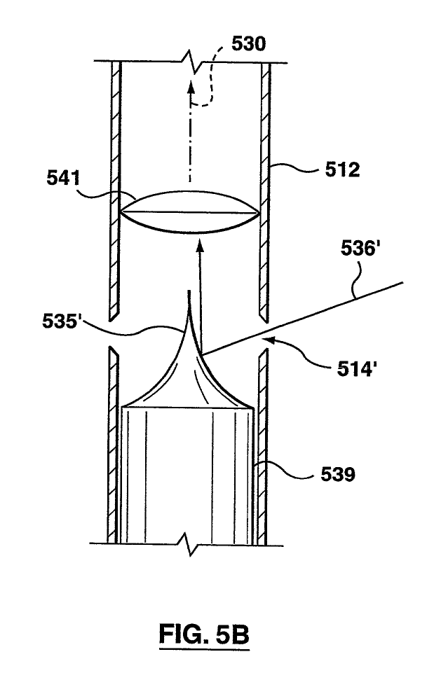

Illustrated in FIG. 5A is a second embodiment of the radiometry system of the subject invention. The radiometry system, shown generally as 500, includes a housing 512, an inlet port 514, a radiation sensor 516, a controller 518 and a display 520.

The housing 512 is roughly cylindrical in shape and preferably is made of metal or other materials which are substantially unaffected by radiation of the type intended to be used in association with the radiometry system 500. The housing comprises an upper assembly 522 detachably mounted to a base 524, as will be explained in greater detail below.

The inlet port 514 generally comprises a radiation passageway through the housing 512, typically in the form of an annular aperture circumscribing all or a substantial portion of the housing 512 perimeter. However, as will be understood, the passageway could comprise radiation transmissive material such as glass or plastic which has been selected to transmit the radiation. The inlet port 514 could also comprise a plurality of apertures which collectively extend substantially around all or a substantial portion of the periphery of the housing 512. As will be understood, the configuration of the inlet port 512 may be selected to correspond to the emission pattern of a radiation emitting device.

The housing 512 comprises a tubular interior chamber 526 which contains a cladded glass rod waveguide 528 having a longitudinal axis 530 and fixed in position within the chamber 526, for example through the use of a set-screw 532 through the housing 512. The waveguide 528 is typically tubular, and more preferably substantially cylindrical. As will be understood, while the waveguide 528 has been described as being made of cladded glass, other materials suitable for acting as a waveguide may be used.

A substantially conical reflector 535 is positioned proximate the inlet port 514. The reflector 535 may be made of polished aluminum and is preferably a right circular cone positioned proximate the inlet port 514 and aligned with the longitudinal axis 530. A radiation transmissive support sleeve 537 may be adhered to the bottom of the waveguide 528 and also to the outer periphery of the reflector 535 near its base. The support sleeve 537 is made of a material such as plastic which provides sufficient structural integrity to support the weight of the upper assembly 522. The reflector 535 may in turn be mounted to a support 539 which may be detachably mountable to the base 524, typically by friction fitting or by threading into a socket in the base 524. As will be understood, the angle 538 of the reflector 535 is selected based on the angle of the radiation entering the input port 514 (represented by vectors 536). In the instant example in which the incident radiation 536 is substantially perpendicular to the longitudinal axis 530, the angle 538 of the reflector 535 is 45°, such that the incident radiation 536 is reflected 90° upwards towards the radiation sensor 516.

The upper assembly 522 may also comprise an indented portion 540 which is sized and shaped to receive a radiation emitting apparatus, such as the curing cylinder 200 illustrated in and discussed in relation to FIG. 2. At the indented portion, the housing 512 is generally narrow in diameter. Preferably the recessed region 540 is sized to enable the inlet port 14 to be positioned proximate the emitter ports on the curing cylinder 200. As will be understood, the curing cylinder 200 or other radiation emitting apparatus to be tested by the radiometry system 10 is fixed in position relative to the upper assembly 522. As will also be understood, the recessed region 540 may be inserted within the irradiation chamber of the curing cylinder 200 by detaching the upper assembly 522 from the base 524.

The radiation sensor 516 will preferably comprise an array of photodiodes or other devices capable of detecting irradiance and generating corresponding irradiance data. As will be understood, each photodiode in the array will correlate to angle of orientation from which the incident radiation 536 has entered the inlet port 514. The controller 518 comprises memory storage and a suitably programmed CPU configured to receive irradiance data from each photodiode in the radiation sensor 516 array, and determine the corresponding orientation data. The display 520 is operationally coupled to the controller 518 and may comprise a display screen, printer or other suitable device for presenting the correlated orientation and irradiance data to the user.

In use, the inlet port 514 is positioned proximate the emitter port(s) of a radiation emitting apparatus (such as the curing cylinder 200). This is typically accomplished by detaching the upper assembly 522 from the base 524, and inserting the indented portion 540 within the irradiation chamber 214, and remounting the upper assembly 522 to the base 524. The radiation emitting apparatus is then fixed in relation to the housing 512.

The radiation emitting apparatus is then caused to emit radiation through its emitter port(s). The emitted radiation is received by the inlet port and directed to the array of photodiodes in the radiation sensor 516, which senses the power of the received radiation impinging on each photodiode, and generates corresponding irradiance data correlated to each photodiode which is received by the controller 518. The irradiance data is calculated through correlating the field of view of each photodiode to the corresponding portion of the inlet port 514. The controller 518 then determines orientation data based on the location of each photodiode in the array and correlates the orientation and irradiance data, which are displayed to the user by the display 520. As will be understood, the radiation sensor 516 and the controller 518 may also be adapted to detect the total irradiance of received radiation 536 (from all angles) and display data to the user on the display 520 correlated to the total power of the radiation 536.

Illustrated in FIG. 5B is an alternate configuration of a reflective cone and surrounding components which may be used in the second embodiment of the radiometry system 500. To improve the quantity of radiation detected by the radiation sensor 516, a conical reflector 535′ having a concave surface capable of reflecting incident radiation 536′ from a broader range of angles than substantially perpendicular to the longitudinal axis 530. The curve of the concave surface may preferably be parabolic or elliptical. The inlet port 514′ may also be beveled to allow a broader angular range of radiation to be received. The surface of the cone 535′ may be adapted to diffuse the incident radiation 536′, to obtain an isotropic irradiance measurement by the radiation sensor 516. Additionally, to improve the signal-to-noise ratio of the radiation detected by the sensor 516, the waveguide 528 may be replaced with a lens 541 or other imaging optics to focus the incident radiation 536′.

With appropriate changes to the controller 518, the radiometry system 500 may also include a jack stage similar to the jack stage 625 discussed with respect to FIG. 6, below.

Referring now to FIG. 6, illustrated therein is a third embodiment of the radiometry system, shown generally as 600. The system 600 is generally similar to the radiometry system 10, illustrated in FIG. 1, and includes a housing 612, an inlet port 614, a radiation sensor 616, a controller 618 and a display 620.

The housing 612 is generally cylindrical in shape, preferably without a recessed region 40 of the type illustrated in FIG. 1. In addition to having an upper assembly 622 rotatably mounted to a rotation stage 624, the rotation stage 624 is also mounted to a jack stage 625, which is capable of raising and lowering the upper assembly 622. As will be understood, the jack stage 625 functions as an elevation sensor and detects the relative vertical position of the upper assembly 622 (preferably correlated specifically to the inlet port 614), and generates corresponding vertical positioning data which is received by the controller 618.

The upper assembly 622 comprises a substantially tubular interior chamber 626 which contains a cladded glass rod waveguide 628 having a longitudinal axis 630 and fixed in position within the chamber 626.

The upper assembly 622 may further comprise two upper assembly segments 622^{A} and 622^{B}. The upper segment 622^{A} is detachably mountable to the lower segment 622^{B}, such as by threaded mounting or friction fitting the two segments 622^{A} and 622^{B} together. Such a configuration facilitates the positioning of the radiometry system 10 within a small location such as the radiation chamber 214 of the curing cylinder 200.

As will be understood, the controller 618 comprises memory storage and a suitably programmed CPU configured to receive and correlate vertical position data, orientation data and irradiance data from the jack stage 625, the rotation stage 624 and radiation sensor 616, respectively.

Thus, while what is shown and described herein constitute preferred embodiments of the subject invention, it should be understood that various changes can be made without departing from the subject invention, the scope of which is defined in the appended claims.

We claim:

1. A radiometer comprising:
(a) an inlet port;
(b) a radiation sensor operatively coupled to the inlet port; and
(c) a direction sensor adapted to detect the orientation of the inlet port.

2. A radiometer as claimed in claim 1, further comprising transmission means for transmitting radiation entering the input port to the light sensor.

3. A radiometer as claimed in claim 1 further comprising a controller responsive to the radiation sensor and to the direction sensor, and adapted to correlate irradiance data with orientation data.

4. A radiometer as claimed in claim 1, further comprising means for rotating the inlet port about a longitudinal axis.

5. A radiometer as claimed in claim 1, further comprising a rotation stage.

6. A radiometer as claimed in claim 1, further comprising means for elevating the inlet port and for detecting the elevation of the inlet port.

7. A radiometer as claimed in claim 1, further comprising a jack stage.

8. The radiometer as claimed in claim 7, further comprising a controller responsive to the radiation sensor and to the direction sensor and to the jack stage, and adapted to correlate irradiance data with orientation data and with vertical position data.

9. A radiometer as claimed in claim 2, wherein the transmission means comprises a waveguide.

10. A radiometer as claimed in claim 2, wherein the transmission means comprises imaging optics.

11. A radiometer as claimed in claim 2, wherein the transmission means comprises a glass rod.

12. A radiometer as claimed in claim 9, wherein the waveguide is substantially a truncated cylinder having a face angled with respect to the longitudinal axis of the cylinder.

13. A radiometer as claimed in claim 12, wherein the face is configured to reflect radiation entering the inlet port internally within the waveguide.

14. A radiometer comprising:
(a) a base;
(b) a housing pivotally mounted to the base, wherein the housing comprises an aperture;
(c) a radiation sensor in communication with the aperture and adapted to generate irradiance data; and
(d) an orientation sensor adapted to detect the orientation of the aperture relative to the base and to generate corresponding orientation data.

15. A radiometer as claimed in claim 14, further comprising transmission means for transmitting radiation entering the aperture to the radiation sensor.

16. A radiometer as claimed in claim 14, wherein the housing is substantially cylindrical in shape.

17. A radiometer as claimed in claim 14, further comprising a controller adapted to correlate the irradiance data with the orientation data.

18. A radiometer as claimed in claim 14 further comprising an elevator for raising and lowering the aperture.

19. A radiometer as claimed in claim 18, further comprising an elevation sensor adapted to detect the elevation of the aperture and to generate corresponding vertical position data.

20. A radiometer as claimed in claim 19, further comprising a controller adapted to correlate the vertical position data, the irradiance data and the orientation data

21. A radiometer as claimed in claim 17, further comprising a display operatively coupled to the controller.

22. A radiometer as claimed in claim 14, further comprising a diffuser for diffusing radiation entering the aperture.

23. A radiometer comprising:
(a) a housing comprising at least one aperture;
(b) a radiation sensor adapted to detect the irradiance and direction of origin of radiation entering the aperture.

24. The radiometer as claimed in claim 23, wherein the housing is substantially tubular.

25. The radiometer as claimed in claim 23, wherein the aperture extends around a substantial portion of the housing.

26. The radiometer as claimed in claim 23, further comprising a reflector configured to reflect radiation entering the aperture onto the radiation sensor.

27. The radiometer as claimed in claim 26, wherein the reflector is substantially conical.

28. The radiometer as claimed in claim 26, further comprising transmission means adapted to receive reflected radiation from the reflector and communicate the received radiation to the radiation sensor.

29. The radiometer as claimed in claim 26, further comprising imaging optics for focusing radiation entering the aperture onto the radiation sensor.

30. A method of detecting the irradiance of radiant energy from a source in at least two dimensions, the method comprising the steps of:
(a) providing a radiometer as claimed in claim 1; and
(b) positioning the radiometer in the path of radiant energy emitted from the source.

31. A method of detecting the irradiance of radiant energy from a source in at least two dimensions, the method comprising the steps of:
(a) providing a radiometer as claimed in claim 14; and
(b) positioning the radiometer in the path of radiant energy emitted from the source.

32. A method of detecting the irradiance of radiant energy from a source in at least two dimensions, the method comprising the steps of:
(a) providing a radiometer as claimed in claim 23; and
(b) positioning the radiometer in the path of radiant energy emitted from the source.
